(19) United States
(12) Patent Application Publication
(10) Pub. No.: US 2016/0029229 A1
(43) Pub. Date: Jan. 28, 2016

(54) SYSTEMS AND METHODS FOR STATION SIGNALING IMPAIRED RECEIVER OPERATION

(71) Applicant: QUALCOMM Incorporated, San Diego, CA (US)

(72) Inventors: Rahul Malik, San Diego, CA (US); George Cherian, San Diego, CA (US); Yanjun Sun, San Diego, CA (US)

(21) Appl. No.: 14/810,348

(22) Filed: Jul. 27, 2015

Related U.S. Application Data
(60) Provisional application No. 62/029,984, filed on Jul. 28, 2014.

(51) Int. Cl. H04W 24/04

(52) U.S. Cl. CPC H04W 24/04; H04W 84/12

(57) ABSTRACT

Methods, devices, and computer program products for station signaling impaired receiver operation are disclosed. One aspect of the present disclosure relates to a method of communication in a wireless communication network including determining an impairment causing a packet drop at a first wireless device, the impairment capable of causing the packet drop(s) based on a condition other than poor link conditions. The method further includes generating an indication of the impairment, the indication comprising an identification of the first wireless device and information about the impairment, and transmitting the indication to a second device configured to transmit packets to the wireless device. Another method of communication disclosed comprises receiving an indication that an impairment is capable of inhibiting reception of packets at another wireless device based on a condition other than poor link conditions, and adjusting a behavior of the wireless device that received the indication, based on the indication.

### CROSS REFERENCE TO PRIORITY APPLICATION

This application claims priority under 35 U.S.C. §119(e) to U.S. Provisional Patent Application 62/029,984 entitled “SYSTEMS AND METHODS FOR STATION SIGNALING IMPAIRED RECEIVER OPERATION” filed on Jul. 28, 2014, the disclosure of which is hereby incorporated by reference in its entirety.

### BACKGROUND

1. Field

The present application relates generally to wireless communications, and more specifically to systems, methods, and devices for stations to signal impaired receiver operation. Certain aspects herein relate to allowing a station to signal impaired operations, which may allow the network to work efficiently.

2. Background

In many telecommunication systems, communications networks are used to exchange messages among several interacting, spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks can also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. In some aspects, a device may determine if a packet was received based on the receipt of an acknowledgement message after it finished transmitting. The device may then adjust its actions if such a message is not received. It may be desirable to provide transmitting devices with more information than this, so that such adjustments may be made (or not made) based on better information, and thus allow for more efficient use of the wireless medium.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include providing information to transmitting devices about impairment of a station.

One aspect of the present disclosure relates to a method of communicating in a wireless communication network. The method includes determining an impairment causing a packet drop at a first wireless device, the impairment capable of causing the packet drop(s) based at least in part on a condition other than poor link conditions. The method further includes generating an indication of the impairment, the indication comprising an identification of the first wireless device and information about the impairment. The method further includes transmitting the indication from the first wireless device to a second wireless device configured to transmit packets to the first wireless device.

In some aspects, a wireless device for communicating in a wireless communication network is provided. The wireless device includes a processor configured to determine an impairment causing a packet drop at the wireless device, the impairment capable of causing the packet drop(s) based at least in part on a condition other than poor link conditions. The processor is further configured to generate an indication of the impairment, the indication comprising an identification of the wireless device and information about the impairment. The wireless device also includes a transmitter configured to transmit the indication to a second wireless device configured to transmit packets to the wireless device.

In some aspects, a wireless device for communicating in a wireless communication network is disclosed. The wireless device includes means for determining an impairment causing a packet drop at the wireless device, the impairment capable of causing the packet drop(s) based at least in part on a condition other than poor link conditions. The wireless device further includes means for generating an indication of the impairment, the indication comprising an identification of the wireless device and information about the impairment. The wireless device also includes means for transmitting the indication to a second wireless device configured to transmit packets to the wireless device.

In one aspect, a non-transitory computer readable medium comprising instructions that, when executed, perform a method of communicating within a wireless communication network is disclosed. The method includes determining an impairment causing a packet drop at a first wireless device, the impairment capable of causing the packet drop(s) based at least in part on a condition other than poor link conditions. The method further includes generating an indication of the impairment, the indication comprising an identification of the first wireless device and information about the impairment. The method also includes transmitting the indication of the impairment from the first wireless device to a second wireless device configured to transmit packets to the first wireless device.

One aspect of the present disclosure provides a method of communicating in a wireless communication network. The method includes receiving, at a first wireless device, an indication of an impairment causing a packet drop at a second wireless device, the indication indicating that the impairment is capable of inhibiting reception of packets at the second wireless device based at least in part on a condition other than poor link conditions. The method further includes adjusting a behavior of the first wireless device based on the indication. In some aspects, the indication is received from the second wireless device.

In one aspect, a wireless device for communicating in a wireless communication network is disclosed. The wireless device includes a receiver configured to receive an indication of an impairment causing a packet drop at a second wireless device, the indication indicating that the impairment is capable of inhibiting reception of packets at the second wireless device based at least in part on a condition other than poor link conditions. The wireless device further includes a processor configured to adjust a behavior of the wireless device based on the indication. In some aspects, the receiver is configured to receive the indication from the second wireless device.

One aspect of the present disclosure provides a wireless device for communicating in a wireless communication network. The wireless device includes means for receiving an indication of an impairment causing a packet drop at a second wireless device, the indication indicating that the impairment is capable of inhibiting reception of packets at the second wireless device based at least in part on a condition other than poor link conditions. The wireless device also includes means for adjusting a behavior of the wireless device based on the indication. In some aspects, the wireless device includes means for receiving the indication from the second wireless device.

One aspect of the present disclosure provides a non-transitory computer readable medium comprising instructions that, when executed, perform a method of communicating within a wireless communication network. The method includes receiving, at a wireless device, an indication of an impairment causing a packet drop at a second device, the indication indicating that the impairment is capable of inhibiting reception of packets at the second wireless device based at least in part on a condition other than poor link conditions The method further includes adjusting a behavior of the first wireless device based on the indication. In some aspects, the indication is received from the second wireless device.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a wireless communication system in which aspects of the present disclosure may be employed.

FIG. 2 shows a functional block diagram of an exemplary wireless device that may be employed within the wireless communication system of FIG. 1.

FIG. 3 shows a functional block diagram of exemplary components of a transmitter module that may be utilized in the wireless device of FIG. 2 to transmit wireless communications.

FIG. 4 shows a functional block diagram of exemplary components of a receiving module that may be utilized in the wireless device of FIG. 2 to receive wireless communications.

FIG. 5 illustrates an exemplary format of an indication of an impairment that a wireless device may transmit to another wireless device.

FIG. 6 illustrates an exemplary method of transmitting an indication of impairment, according to some aspects of the present disclosure.

FIG. 7 illustrates an exemplary method of receiving an indication of impairment, according to some aspects of the present disclosure.

### DETAILED DESCRIPTION

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the Institute of Electrical and Electronics Engineers (IEEE) 802.11 family of wireless protocols.

In some aspects, wireless signals may be transmitted according to an 802.11 protocol using orthogonal frequency-division multiplexing (OFDM), orthogonal frequency-division multiple access (OFDMA), direct-sequence spread spectrum (DSSS) communications, a combination of OFDM and DSSS communications, or other schemes.

In some implementations, a WLAN includes various devices which are the components that access the wireless network. For example, there may be two types of devices: access points (“APs”) and clients (also referred to as stations, commonly known as “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

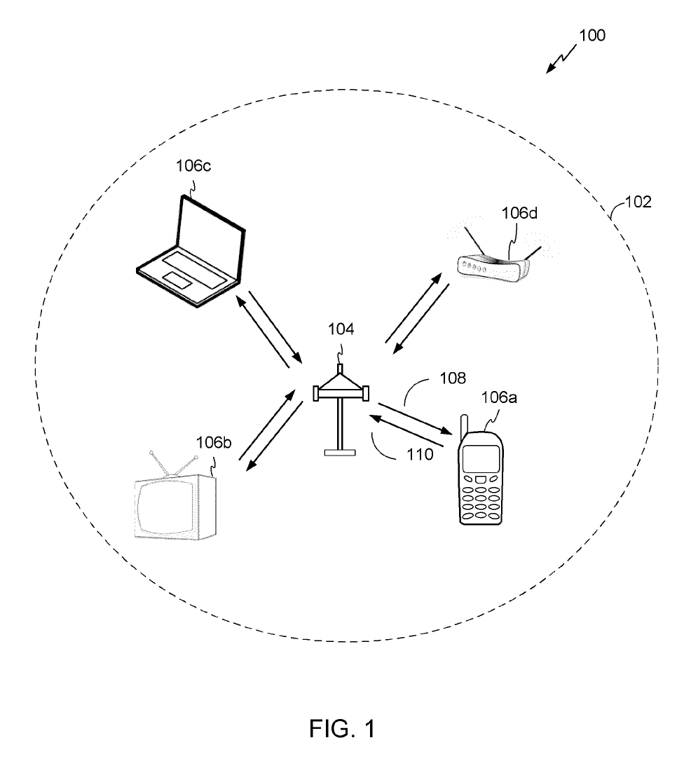

FIG. 1 illustrates an example of a wireless communication system 100 in which aspects of the present disclosure may be employed. The wireless communication system 100 may operate pursuant to a wireless standard. The wireless communication system 100 may include an AP 104, which communicates with STAs 106a-d (referred to herein collectively as “STAs 106” or individually as “STA 106”).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a “central” AP 104, but rather may function as a peer-to-peer network between the STAs 106. Accordingly, the functions of the AP 104 described herein may alternatively be performed by one or more of the STAs 106.

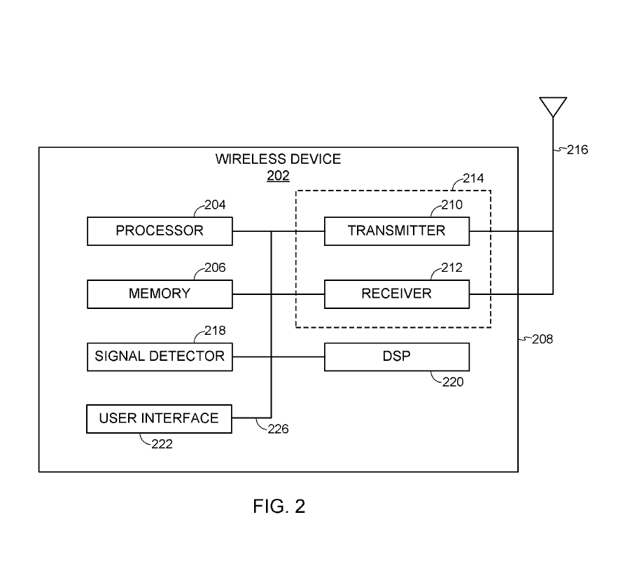

FIG. 2 illustrates a functional block diagram of an exemplary wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

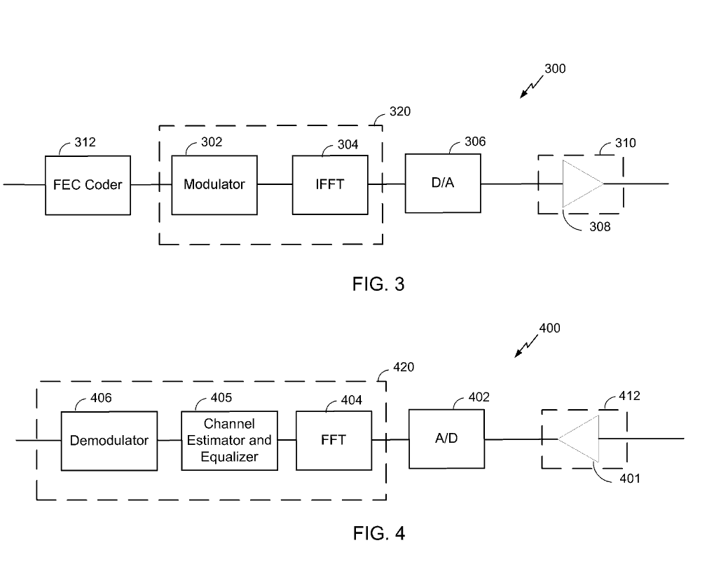

As discussed above, the wireless device 202 may comprise an AP 104 or an STA 106, and may be used to transmit and/or receive communications. FIG. 3 illustrates a functional block diagram of exemplary components of a transmitter module 300 that may be utilized in the wireless device 202 to transmit wireless communications. The components illustrated in FIG. 3 may be used, for example, to transmit OFDM communications.

The transmitter module 300 may comprise a modulator 302 configured to modulate bits for transmission. For example, if the transmitter module 300 is used as a component of wireless device 202 in FIG. 2, the modulator 302 may determine a plurality of symbols from bits received from the processor 204 or the user interface 222, for example by mapping bits to a plurality of symbols according to a constellation. The bits may correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The transmitter module 300 may further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there may be multiple transform modules (not shown) that transform units of data of different sizes.

In FIG. 3, the modulator 302 and the transform module 304 are illustrated as being implemented in the DSP 320. In some aspects, however, one or both of the modulator 302 and the transform module 304 may be implemented in other components of wireless device 202, such as in the processor 204.

Generally, the DSP 320 may be configured to generate a data unit for transmission. In some aspects, the modulator 302 and the transform module 304 may be configured to generate a data unit comprising a plurality of fields including control information and a plurality of data symbols. The fields including the control information may comprise one or more training fields, for example, and one or more signal (SIG) fields. Each of the training fields may include a known sequence of bits or symbols. Each of the SIG fields may include information about the data unit, for example a description of a length or data rate of the data unit.

Returning to the description of FIG. 3, the transmitter module 300 may further comprise a digital to analog converter 306 configured to convert the output of the transform module 304 into an analog signal. For example, the time-domain output of the transform module 304 may be converted to a baseband OFDM signal by the digital to analog converter 306. In some aspects, portions of the transmitter module 300 may be included in wireless device 202 from FIG. 2. For example, the digital to analog converter 306 may be implemented in the transceiver 214, or in another element of the wireless device 202.

The analog signal may be wirelessly transmitted by a transmitter circuit 310. The analog signal may be further processed before being transmitted by the transmitter circuit 310, for example by being filtered or by being upconverted to an intermediate or carrier frequency. In the aspect illustrated in FIG. 3, the transmitter circuit 310 includes a transmit amplifier 308. Prior to being transmitted, the analog signal may be amplified by the transmit amplifier 308.

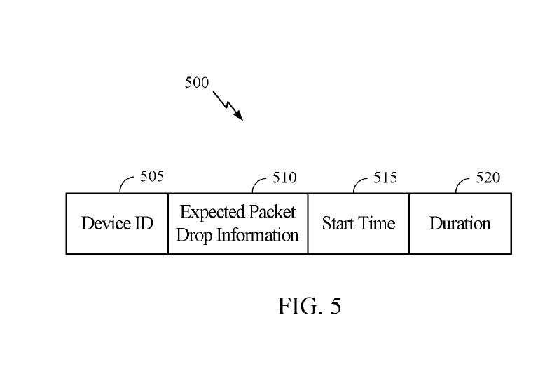

In some aspects, the transmitter circuit 310 is configured to transmit one or more packets or data units in a wireless signal based on the analog signal. The data units may be generated using a processor and/or the DSP 320, for example using the modulator 302 and the transform module 304 as discussed above. In some aspects, transmitter module 300 may further comprise a forward error correction (FEC) coder 312. As illustrated, the FEC coder 312 can be before the modulator 302. In some aspects, the FEC coder 312 may be used to adapt FEC coding based on, for example, a reported impairment, as discussed below. Data units that may be generated and transmitted as discussed above are described in additional detail below with respect to FIGS. 5-7.

FIG. 4 illustrates a functional block diagram of exemplary components of a receiving module 400 that may be utilized in the wireless device 202 to receive wireless communications. The components illustrated in FIG. 4 may be used, for example, to receive OFDM communications. In some aspects, the components illustrated in FIG. 4 are used to receive data units that include one or more training fields, as will be discussed in additional detail below. For example, the components illustrated in FIG. 4 may be used to receive data units transmitted by the components discussed above with respect to FIG. 3.

The receiving module 400 may comprise a receiver circuit 412. The receiver circuit 412 may be configured to receive one or more packets or data units in a wireless signal. Data units that may be received and decoded or otherwise processed as discussed below are described in additional detail with respect to FIGS. 5-7.

In the aspect illustrated in FIG. 4, the receiver circuit 412 includes a receive amplifier 401. The receive amplifier 401 may be configured to amplify the wireless signal received by the receiver circuit 412. In some aspects, the receiver circuit 412 is configured to adjust the gain of the receive amplifier 401 using an automatic gain control (AGC) procedure. In some aspects, the AGC uses information in one or more received training fields, such as a received short training field (STF) for example, to adjust the gain. Those having ordinary skill in the art will understand methods for performing AGC. In some aspects, the amplifier 401 comprises a low-noise amplifier (LNA).

The receiving module 400 may comprise an analog to digital converter 402 configured to convert the amplified wireless signal from the receiver circuit 412 into a digital representation thereof. Further to being amplified, the wireless signal may be processed before being converted by the analog to digital converter 402, for example by being filtered or by being downconverted to an intermediate or baseband frequency. In some aspects, the analog to digital converter 402 may be implemented in the transceiver 214, or in another element of the wireless device 202.

The receiving module 400 may further comprise a transform module 404 configured to convert the representation the wireless signal into a frequency spectrum. In FIG. 4, the transform module 404 is illustrated as being implemented by a fast Fourier transform (FFT) module. In some aspects, the transform module 404 may identify a symbol for each point that it uses.

The receiving module 400 may further comprise a channel estimator and equalizer 405 configured to form an estimate of the channel over which the data unit is received, and to remove certain effects of the channel based on the channel estimate. For example, the channel estimator may be configured to approximate a function of the channel, and the channel equalizer may be configured to apply an inverse of that function to the data in the frequency spectrum.

In some aspects, the channel estimator and equalizer 405 uses information in one or more received training fields, such as a long training field (LTF) for example, to estimate the channel. The channel estimate may be formed based on one or more LTFs received at the beginning of the data unit. This channel estimate may thereafter be used to equalize data symbols that follow the one or more LTFs. After a certain period of time or after a certain number of data symbols, one or more additional LTFs may be received in the data unit. The channel estimate may be updated or a new estimate formed using the additional LTFs. This new or updated channel estimate may be used to equalize data symbols that follow the additional LTFs. In some aspects, the new or updated channel estimate is used to re-equalize data symbols preceding the additional LTFs. Those having ordinary skill in the art will understand methods for forming a channel estimate.

The receiving module 400 may further comprise a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. As illustrated, in some aspects, the transform module 404, the channel estimator and equalizer 405, and the demodulator 406 may be implemented as part of a DSP 420. In some aspects, where the receiving module 400 is implemented as a portion of wireless device 202, bits may be processed or evaluated by the processor 204, or used to display or otherwise output information to the user interface 222. In this way, data and/or information may be decoded. In some aspects, the bits correspond to codewords. In one aspect, the demodulator 406 comprises a QAM demodulator, for example a 16-QAM demodulator or a 64-QAM demodulator. In other aspects, the demodulator 406 comprises a BPSK demodulator or a QPSK demodulator.

### Station Impairment Signaling

In a wireless network, a first wireless device may transmit information in a frame or a number of frames to a second wireless device. The first and second wireless device may be similar to one of the STAs 106 or the AP 104 of FIG. 1, or the wireless device 202 of FIG. 2. After the first device has transmitted a frame or a number of frames to the second device, the second device may respond with an acknowledgement (ACK) or block-acknowledgement (block-ACK or BA) message, indicating receipt of the information from the first device. When the transmission of both the initial information and the ACK is successful, the first device may receive the ACK and be aware that transmission was successful. However, if the first device does not receive an ACK message, the first device may be aware that transmission of either the information or the ACK was unsuccessful. Accordingly, in various embodiments, the first device may take one or more of a number of actions. For example, the first device may, after one or more failed transmission, adjust a rate at which the information is transmitted. The first device may adjust the transmission such that the transmission is transmitted at a slower data rate, but capable of being received at a greater distance. Accordingly, this transmission may take more time, but may have a higher likelihood of being received by the second device. Such adjustments may be made, for example, by transmitting using a different Modulation and Coding Scheme (MCS), as indicated by an MCS index value in a transmission.

In some aspects, if the second device was unable to receive a transmission because it was too far away from the first device or the signal was too weak, adjusting MCS values to allow for longer distance transmission (at the cost of packets which take more time to transmit) may be effective. Such adjustments, in this circumstance, may make it more likely that the second device will receive the packet. However, such adjustments may be ineffective, or even counter-productive, in circumstances where the second device does not receive one or more packets due to an impairment. For example, the second device may be in the proximity of a “hidden node,” that is, another device which is transmitting on an overlapping portion of the bandwidth with the first device, but where the first device is not aware of the hidden node. In such a hidden node situation, a failure of the second device to receive the packet may be due to interference from the hidden node, rather than distance between the first and second device. Thus, if the first device switches to another MCS index, wherein packets will take more time to transmit, this may increase rather than decrease the likelihood of failure, as there will be more possible time in which interference from the hidden node may occur. Reduction in MCS in this scenario may also have other unintended consequences, such as “spiraling of death,” where lowering MCS increases the packet transmission time thereby further increasing the probability of getting hit by the impairment. Thus, it can be important for the transmitter to be aware of the type of impairment causing packet loss (e.g., causing a packet drop) at the receiver in order to use a better rate adaptation strategy. In some aspects, the packet drop may be referred to as an interruption to WLAN operation at the receiver. In various aspects, the interruption may not be due to poor link conditions. In some aspects, the packet drop may refer to a packet that is not delivered to or received by an intended recipient of the packet. In some aspects, the packet drop may refer to a packet that is received by the intended recipient of the packet, but is otherwise corrupted, unreadable, or missing at least a portion of data contained in the packet.

Accordingly, in some aspects, it may be beneficial to allow a receiving device, such as a STA 106 or an AP 104, to inform a transmitting device, such as another STA 106 or an AP 104, of an impairment in the receiving capabilities of the receiving device. This indication of the impairment may allow a transmitting device to choose to adjust, or not adjust, its actions based on the knowledge of this impairment. Accordingly, the transmitting device may be able to make informed decisions about when to transmit, what channels or bandwidth to transmit on, what rate-adaptation strategy to use and data rate to use when transmitting.

There are a number of different scenarios which may interrupt WLAN operation on a STA 106. For example, a STA 106 may include Bluetooth functionality. Some implementations of Bluetooth functionality perform hardware sharing between Bluetooth and WLAN, and give a priority to Bluetooth traffic, since Bluetooth is generally used for real-time applications, such as streaming voice or audio. In such a STA 106 with hardware sharing, when the Bluetooth radio is transmitting or receiving, WLAN reception may be disabled. Accordingly, when a STA 106 uses hardware sharing and has Bluetooth enabled, some WLAN packets which are transmitted to the STA 106 may not be received by the STA 106, simply due to the use of the radio for Bluetooth rather than WLAN. Accordingly, in such a circumstance, if a transmitting device was unaware of the Bluetooth operation, its corrections (such as transmitting packets using a different MCS which might make the packets temporally longer, but able to be transmitted greater distance) may be counterproductive (as a temporally longer packet may be more likely to suffer from occurring during a Bluetooth transmission/reception at the STA 106, thus resulting in even greater loss of network efficiency).

Similar to Bluetooth, WLAN reception may also be impaired by operation of a LTE (Long Term Evolution) device at or near a STA 106. The spectrum which is allocated to LTE devices varies by geographic location, but several geographies have an LTE spectrum which is allocated adjacent to portions of the WLAN spectrum. For example, LTE band B40 and B7 may be adjacent to a 2.4 GHz WLAN spectrum. Generally, LTE may be transmitted at a higher power level than WLAN, and this may result in collisions between LTE and WLAN transmissions, or may jam the WLAN receiver at times. In some aspects, a STA 106 may also use hardware sharing between WLAN and LTE communications, such that the STA 106 is unable to use a WLAN receiver when LTE is in use. Accordingly, LTE may impair operation of a receiver on STA 106.

In some aspects, the WLAN operation of a STA 106 may also be impaired by the operation of an LTE Unlicensed (LTE-U) device at or near the STA 106. LTE-U may be operated on a wide variety of portions of the spectrum, rather than merely operating on the portion of the spectrum which is reserved in that geography for LTE. Accordingly, LTE-U may operate on the same channel as WLAN, or on adjacent channels. As with LTE, the higher transmit power of LTE-U may result in collisions or at times jamming of the WLAN received. In some aspects, a STA 106 may also use hardware sharing between WLAN and LTE-U communications, such that the STA 106 is unable to use a WLAN receiver when LTE-U is in use. Accordingly, LTE-U may impair operation of a receiver on STA 106.

Further, operation of a WLAN device within range of other WLAN devices on the same channel may impair operation. As discussed above, the “hidden node” problem may impair WLAN performance as well.

In any of these circumstances, it may be desirable to provide a mechanism whereby a WLAN device may signal to other devices that it suffers from some form of recurring reception impairment for reasons other than simply distance and/or weak reception. For example, a WLAN device may be able to signal an intermittent impairment that will result in a higher rate of retransmissions to the WLAN device, such as impairment due to interference or hardware sharing. Without such signaling, a transmitting device may not be aware of the nature of errors at the receiving STA 106, and may react undesirably (such as by performing rate adaptation, resulting in dropping the MCS) and consequently may lower throughputs and lower wireless medium efficiency. Accordingly, signaling the nature of errors or impairment experienced by a receiving WLAN device to a transmitting WLAN device may be used to improve overall WLAN performance.

FIG. 5 illustrates an exemplary format of an indication 500 of an impairment that a STA 106 may transmit to another wireless device. In some aspects, the STA 106 may transmit an indication of its own identification 505 to another device as part of the indication 500. In some aspects, the indication 500 transmitted by the STA 106 may optionally comprise a descriptor of the impairment, such as information on an expected packet drop 510 (or on expected packet drops), a start time 515 of the impairment, an end time of the impairment, or a duration 520 of the impairment. In some aspects, the STA 106 may generate the indication 500 to signal the onset of the impairment condition (e.g., launching of a Bluetooth call) as well as a subsequent indication 500 to indicate the conclusion of the impairment condition (e.g., termination of a Bluetooth call). Generally, a receiving (Rx) STA 106 may signal its awareness of a scenario that may result in frequent packet drops for reasons other than poor link conditions to a transmitting (Tx) STA 106. In various aspects, the information on an expected packet drop 510 can include an indication of a 2.4 GHz band, or sub-band thereof (such as the primary 20, secondary 40, etc) on which intermittent packet drops are expected. In some aspects, the information on an expected packet drop 510 may comprise an indication of a 5 GHz band or sub-band on which an intermittent packet drop is expected (e.g., an expected intermittent packet drop or expected intermittent packet drops). The information on an expected packet drop 510 may include an indication of an expected interference in either the current operational channel, in an adjacent operational channel, or in another operational channel. When interference is co-located (such as interference from the same device, like when hardware sharing is used), the STA 106 may indicate a start time 515 of the interference, when known, as well as a duration 520 of the interference. In some aspects, the duration 520 of the interference may be indicated by indicating a stop time of the interference. In some aspects, a start time 515 may be known, and the duration 520 may be unknown, or may be indicated later. For example, a device may not be aware of the end time of Bluetooth use. In such an example, a subsequent indication 500 may be issued containing duration 520 information corresponding to the end of the interference event. Indication 500 from the STA 106 may be carried via an 802.11 information element (e.g., embedded in a frame), including potentially being carried by a new information element which has been designed for the purpose of carrying the above information. In another embodiment, the information may be carried by a new control or management frame, or as a data payload in a data frame.

A station that is transmitting, or attempting to transmit one or more packets in a wireless communication network (referred to herein as a transmitting STA 106 or Tx STA 106) may take a number of actions upon receiving an indication, such as indication 500 or parts thereof. In some aspects, the Tx STA 106 may receive this indication 500 from a station that is receiving, or attempting to receive the one or more transmitted packets (referred to herein as a receiving STA 106 or Rx STA 106). For example, the Tx STA 106 may alter its rate adaptation strategy, in such a manner as to eliminate or reduce the impact of intermittent interference or errors on rate/MCS selection for packets destined to the signaling STA. A Tx STA 106 may also adjust is maximum packet size (e.g., A-MPDU size) or burst time, or a duration of a transmit opportunity (TXOP) used, in order to give the STA 106 frequent contention opportunities or for example, get more frequent feedback in the form of a block-ACK. The Tx STA 106 may also teardown or limit its BA sessions with its clients based on the indication 500. In the context of the Tx STA 106 being implemented as an AP, the Tx STA 106 may also alter a duration of a transmission opportunity (TXOP) or transmission opportunities (TXOPs) supported in the network, in order to further reduce single-user dwell times (during which only a single device is allowed to use the medium), thus increasing contention opportunities. Generally, these changes may allow for more frequent but shorter uses of the wireless medium, which may be beneficial when certain devices on the network suffer from intermittent or periodic interruption in WLAN service or capabilities. The Tx STA 106 may also assist the signaling Rx STA 106 to transition to another band or channel. For example, other mechanisms described in an IEEE 802.11 specification, such as in 802.11k, may be triggered to allow an assessment of what channels to move to. This transition to another channel could then be made using mechanisms such as those described in the IEEE 802.11v standard. In some aspects, the Tx STA 106 may also make a decision to migrate the BSS (basic service set) to another band or channel, and may subsequently migrate the BSS thereto, in order to aid the reception of the indicating Rx STA 106. In some aspects, the Tx STA 106 may adjust one or more of a backoff window setting or a retry limit. In some aspects, the Tx STA 106 may adjust its transmission schedule.

Generally, the use of the indication 500 may aid in resolving limitations of the existing approaches. For example, existing signaling methods such as U-APSD (Unscheduled Automatic Power Save Delivery) and PS (power save) exist in the context of power-save, but may be over-loaded to signal the absence of a STA 106, such as the inability to receive a transmission. Generally, these approaches are optimized to larger time-scales, and are impractical to use for frequent interference of a low and frequently occurring duration. Moreover, these mechanisms have to be designed-in (e.g., the STA 106 may send a Power-Save signaling when it knows of an impending Bluetooth transmission), and cannot cover all scenarios. This may be especially the case when the cause of the interference is not known, such as a hidden node. For example, in the case of Bluetooth, which may need to transmit during frequent short intervals, a separate sleep or wake message may need to be transmitted each and every time that a Bluetooth transmission either starts or stops, resulting in numerous messages transmitted millisecond apart. This would create a large amount of network overhead, and would be very inefficient.

In IEEE 802.11v, newer signaling methods such as U-APSD Coexistence have been developed. These may be used to make the Tx STA 106 aware of recurring (periodic) interference at the Rx STA 106, but are not amenable to impaired operation epochs that are not known a priori. For example, these methods may make an implicit assumption that interference begins at known instants in time, and may therefore not be useful when the interference is caused by a device other than the Rx STA 106, or when the interference may start or stop at unknown times. Further, other methods of signaling interference, such as short interference signaling to the transmitting STA rely on the assumption that the Rx STA 106 received some of the SDUs (service data units) carried in the PPDU.

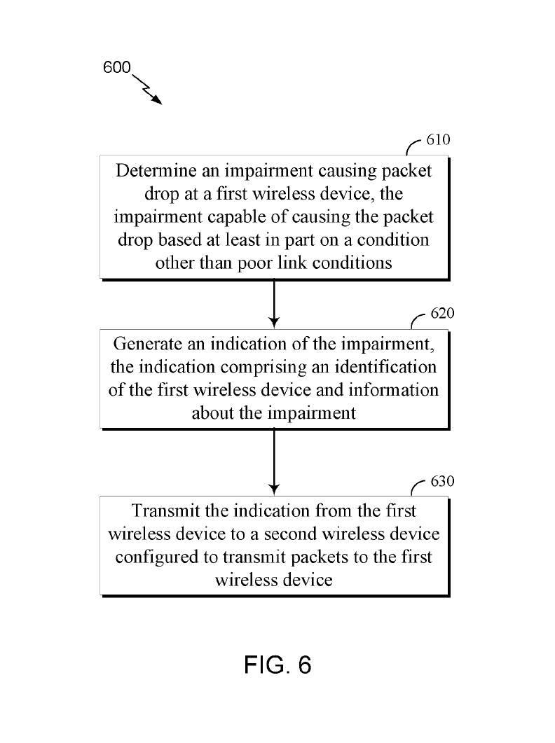

FIG. 6 illustrates an exemplary method 600 of transmitting an indication of impairment, according to some aspects of the present disclosure. This method may be used by a wireless device 202 or a Rx STA 106 which is limited by some form of intermittent or periodic impairment, like those described above.

At block 610, the method includes determining an impairment causing (or capable of causing) a packet drop at a first wireless device, the impairment capable of causing the packet drop(s) based at least in part on a condition other than poor link conditions. For example, this impairment may be caused by Bluetooth, LTE, LTE-U, a hidden node, or another type of impairment. In some aspects, this impairment may be the result of hardware sharing on the Rx STA 106, such that the Rx STA 106 may not be able to receive messages from a Tx STA 106 at certain times.

At block 620, the method includes generating an indication of the impairment, the indication comprising an identification of the first wireless device and information about the impairment. For example, the indication of the impairment may inform a receiving device which particular band, bands, sub-band, or sub-bands (e.g., one or more particular bands) on which the wireless device may have interruptions. In some aspects, the indication may also comprise a descriptor of the impairment, such as an indication of a start time, a duration, and/or an end time for the impairment.

At block 630, the method includes transmitting the indication from the first wireless device to a second wireless device configured to transmit packets to the first wireless device. For example, this transmission may be included in an information element, such as a vendor specific element, a data or management frame, or a new control frame. This indication may be used by a receiving device to better determine when and how to adjust to packets that the Rx STA 106 may fail to receive correctly. In some aspects, the indication may be transmitted via an IEEE 802.11 information element embedded in a frame.

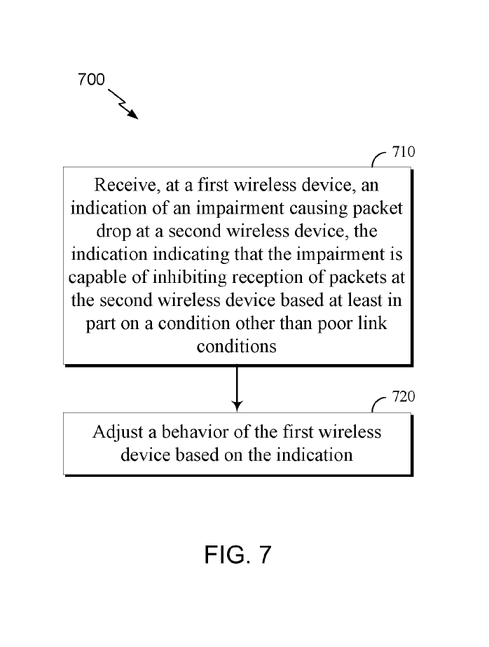

FIG. 7 illustrates an exemplary method 700 of receiving an indication of impairment, according to some aspects of the present disclosure. For example, a Tx STA 106 may receive an indication from a Rx STA 106, where the indication informs the Tx STA 106 of some form of reception impairment on the Rx STA 106. Such an indication may be used to help the Tx STA 106 adjust its behavior in order to facilitate more efficient use of the wireless medium, compared to the behavior of the devices without the indication.

At block 710, the method includes receiving, at a first wireless device, an indication of an impairment causing (or capable of causing) a packet drop at a second wireless device, the indication indicating that the impairment is capable of inhibiting reception of packets at the second wireless device based at least in part on a condition other than poor link conditions. For example, the first wireless device may be a Tx STA 106, while the second device may be a Rx STA 106. Because the first wireless device may transmit to the second device (such as when one device is an AP 104 and the other is a STA 106 associated with that AP), it may be beneficial for the transmitting device to be aware of impairments of the reception of the receiving device. Without knowledge of such impairments, the transmitting device may function in a manner designed to optimize likelihood of reception if the receiving device has poor link conditions (such as a weak signal or a low signal-to-noise ratio due to distance or objects between the two devices). But in some cases, the receiving device may have an impairment that is unrelated to poor link conditions, such as when there is a hidden node, or co-location of an interfering service (either interfering with some or all of the bandwidth, or using hardware sharing). Accordingly, those impairments may otherwise be unknown to the transmitting device, but for the indication. In some aspects, the indication may be transmitted by the second wireless device.

At block 720, the method includes adjusting a behavior of the first wireless device based on the indication. For example, the Tx STA 106 may adjust the frequency and lengths of contention windows, transmission opportunities, or other values in order to allow for more frequent but shorter communication windows. Shorter windows of time may be beneficial for a device suffering from intermittent impairment, as it may allow that device to be more likely to transmit or receive a packet without the interference occurring during that transmission/reception window and/or provide more opportunities for feedback in the form of block-ACK packets. The Tx STA 106 may also adjust in other ways, based on the nature of the impairment. For example, if the indication informs the Tx STA 106 that the impairment is limited to a certain channel or certain channels, certain band, bands, sub-band, or sub-bands, the Tx STA 106 may alter its behavior such as to transmit information on one or more unimpaired bands as much as possible. In some aspects, the Tx STA 106 may move the BSS to another band or channel, or may assist the Rx STA 106 to transition to another band or channel—such as roaming to another AP 104 that is in the same BSS but on another band/channel. In some aspects, the Tx STA 106 may transmit a message to the Rx STA 106, the message based, at least in part, on the received indication. For example, the message may be a future data packet to the Rx STA 106, which is transmitted in a different way (such as on a different channel) than it would be transmitted absence of the indication. In some aspects, adjusting the behavior of the first wireless device comprises adjusting a maximum packet size.

### Implementing Systems and Terminology

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-7 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims. For example, in some aspects, the means for determining may include a processor 204, a memory 206, the functional equivalents thereof, or some combination thereof. In some aspects, the means for adjusting behavior may include may include a processor 204, a memory 206, the functional equivalents thereof, or some combination thereof. In some aspects, the means for generating the indication may include may include a processor 204, a memory 206, the functional equivalents thereof, or some combination thereof. In some aspects, the means for transmitting may include a transmitter 210, a transceiver 214, the functional equivalents thereof, or some combination thereof. In some aspects, the means for receiving the indication may include a receiver 212, a transceiver 214, the functional equivalents thereof, or some combination thereof. In some aspects, the means for altering, the means for migrating, or the means for adjusting one or more of a backoff window setting or a retry limit may include may include a processor 204, a memory 206, the functional equivalents thereof, or some combination thereof.

If implemented in software, the functions may be stored on or transmitted over as one or more instructions or code on a computer readable medium. The steps of a method or algorithm disclosed herein may be implemented in a processor-executable software module which may reside on a computer readable medium. Computer readable media includes both computer storage media and communication media including any medium that can be enabled to transfer a computer program from one place to another. A storage media may be any available media that may be accessed by a computer. By way of example, and not limitation, such computer readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer readable media. Additionally, the operations of a method or algorithm may reside as one or any combination or set of codes and instructions on a machine readable medium and computer readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of communicating in a wireless communication network, the method comprising:
determining an impairment causing a packet drop at a first wireless device, the impairment capable of causing the packet drop based at least in part on a condition other than poor link conditions;
generating an indication of the impairment, the indication comprising an identification of the first wireless device and information about the impairment; and
transmitting the indication from the first wireless device to a second wireless device configured to transmit packets to the first wireless device.

2. The method of claim 1, wherein the information about the impairment comprises an indication of an expected intermittent packet drop in one or more particular bands or sub-bands.

3. The method of claim 1, wherein the information about the impairment comprises an indication of an expected interference in a current operational channel or another operational channel.

4. The method of claim 1, wherein the indication further comprises a descriptor of the impairment.

5. The method of claim 4, wherein the descriptor comprises one or more of a start time of the impairment, a duration of the impairment, and an end time of the impairment.

6. The method of claim 1, wherein transmitting the indication comprises transmitting the indication via an IEEE 802.11 information element embedded in a frame.

7. A first wireless device for communicating in a wireless communication network, the first wireless device comprising:
a processor configured to:
determine an impairment causing a packet drop at the first wireless device, the impairment capable of causing the packet drop based at least in part on a condition other than poor link conditions;
generate an indication of the impairment, the indication comprising an identification of the first wireless device and information about the impairment; and
a transmitter configured to transmit the indication to a second wireless device configured to transmit packets to the first wireless device.

8. The first wireless device of claim 7, wherein the information about the impairment comprises an indication of an expected intermittent packet drop in one or more particular bands or sub-bands.

9. The first wireless device of claim 7, wherein the information about the impairment comprises an indication of an expected interference in a current operational channel or an adjacent operational channel.

10. The first wireless device of claim 7, wherein the indication further comprises a descriptor of the impairment.

11. The first wireless device of claim 10, wherein the descriptor comprises one or more of a start time of the impairment, a duration of the impairment, and an end time of the impairment.

12. The first wireless device of claim 7, wherein the transmitter is further configured to transmit the indication via an IEEE 802.11 information element embedded in a frame.

13. A method of communicating in a wireless communication network, the method comprising:
receiving, at a first wireless device, an indication of an impairment causing a packet drop at a second wireless device, the indication indicating that the impairment is capable of inhibiting reception of packets at the second wireless device based at least in part on a condition other than poor link conditions; and
adjusting a behavior of the first wireless device based on the indication.

14. The method of claim 13, wherein adjusting the behavior of the first wireless device comprises altering a rate adaptation strategy for packets transmitted to the second wireless device to reduce an impact of intermittent interference on Modulation and Coding Scheme selection.

15. The method of claim 13, wherein adjusting the behavior of the first wireless device comprises adjusting a maximum packet size.

16. The method of claim 13, wherein adjusting the behavior of the first wireless device comprises adjusting a duration of a transmission opportunity.

17. The method of claim 13, wherein adjusting the behavior of the first wireless device comprises migrating to another band or channel or assisting the second wireless device in transitioning to another band or channel.

18. The method of claim 13, wherein adjusting the behavior of the first wireless device comprises adjusting one or more of a backoff window setting or a retry limit.

19. The method of claim 13, wherein adjusting the behavior of the first wireless device comprises adjusting a transmission schedule of the first wireless device.

20. A first wireless device for communicating in a wireless communication network, the first wireless device comprising:
a receiver configured to receive an indication of an impairment causing a packet drop at a second wireless device, the indication indicating that the impairment is capable of inhibiting reception of packets at the second wireless device based at least in part on a condition other than poor link conditions; and
a processor configured to adjust a behavior of the first wireless device based on the indication.

21. The first wireless device of claim 20, wherein adjusting the behavior of the first wireless device comprises altering a rate adaptation strategy for packets transmitted to the second wireless device to reduce an impact of intermittent interference on Modulation and Coding Scheme selection.

22. The first wireless device of claim 20, wherein adjusting the behavior of the first wireless device comprises adjusting a maximum packet size.

23. The first wireless device of claim 20, wherein adjusting the behavior of the first wireless device comprises adjusting a duration of a transmission opportunity.

24. The first wireless device of claim 20, wherein adjusting the behavior of the first wireless device comprises migrating to another band or channel or assisting the another wireless device in transitioning to another band or channel.

25. The first wireless device of claim 20, wherein adjusting the behavior of the first wireless device comprises adjusting one or more of a backoff window setting or a retry limit.

26. The first wireless device of claim 20, wherein adjusting the behavior of the wireless device comprises adjusting a transmission schedule of the first wireless device.
